(19) United States
(12) Patent Application Publication
(10) Pub. No.: US 2009/0314861 A1
(43) Pub. Date: Dec. 24, 2009

(54) Fluid ejection using multiple voltage pulses and removable modules

(76) Inventor: Jaan Noolandi, Mountain View, CA (US)

Correspondence Address: LUMEN PATENT FIRM, 350 Cambridge, Suite 100, PALO ALTO, CA, 94306, US

(21) Appl. No.: 12/214,552

(22) Filed: Jun. 18, 2008

(51) Int. Cl. B05B 5/00

(52) U.S. Cl. 239/690; 239/3

(57) ABSTRACT

Fluid ejection using multiple voltage pulses and removable well modules is provided. Ejection of an electrically conductive fluid is accomplished by the application of two or more high voltage pulses. The high voltage pulses are applied across a conducting nozzle for transporting the fluid and a grounded conducting ring positioned below the nozzle. Ejected fluid droplets fall through the center of the conducting ring and onto a substrate. The presence and approximate size of the ejected droplets can be sensed and used for feedback for the high voltage pulses. The conductive fluids are stored in well modules that are not permanently attached to a well plate. Each removable well module includes a conducting nozzle and can include valves and a memory chip. Control circuits are also provided to independently control the high voltage pulses applied to the individual well modules.

### FIELD OF THE INVENTION

The invention relates generally to dispensing electrically conductive fluids. More particularly, the present invention relates to biological fluid droplet ejection using high voltage pulses.

### BACKGROUND

A substantial need exists for accurate low cost microarrays or bioarrays for biopharmaceutical, genetic research, and emerging clinical applications, such as identifying chemicals and pathogens, screening patients for drug sensitivity, diagnosing diseases, and genetic or proteomic research. Current methods for producing microarrays can be expensive and impractical. Typically, microarray production is a slow complicated process that requires building up genes individually base by base on a slide.

Some existing techniques of printing microarrays use contact methods that require dipping pins into solution and touching the dipped pins on a substrate. In addition to being time-consuming, contact methods for microarray production are prone to contamination as the pins come in direct contact with substrates, have problems with substrate fragility, and are typically wasteful as excess biochemical material is discarded after printing.

Because of the above difficulties, particularly cost, researchers often rely on custom-made or “homebrew” techniques. However, homebrew array printers are often non-standard, unreliable, slow, and only capable of producing relatively large (about 100 μm) spots. In addition, homebrew printers typically require a dedicated operator and frequent maintenance. Furthermore, the homebrew array printers use contact methods, which have the above-mentioned disadvantages.

Existing techniques of printing microarrays oftentimes also use modified standard well plates by storing and dispensing fluids directly in the wells of the well plates. By using standard well plates, standard handling equipment need not be replaced with custom or dedicated handling equipment. However, existing techniques using standard well plates have difficulties with filling, storing, transporting, and cleaning the well plates. In addition, keeping track of which fluids are in each well and sealing the partially-used well for future use are difficult to accomplish for the modified standard well plates of existing techniques. Precise modification of the standard well plates, such as welding small nozzles onto the wells of the well plates, causes the well plates to be fragile during filling, transporting, and storage. The use of existing modified standard well plates can also be wasteful as damage to printing equipment at one well could require the replacement of the entire well plate. Furthermore, existing modified well plates are not easily reusable, since wells could run dry at different rates.

The present invention addresses at least the difficult problems of precise fluid printing and advances the art with electrically conductive fluid ejection using high voltages.

### SUMMARY OF THE INVENTION

The present invention is directed to printing or ejecting a conductive fluid or powder using high voltage pulses. A nozzle, including a first conductor, is provided for transporting an electrically conductive fluid, such as a biological fluid, a DNA sample, a virus, a cell, a protein, or any mixture thereof, is provided. A second conductor, positioned below the nozzle, is also provided. A first voltage pulse is applied across the first and second conductors to form an approximately hemispherical hanging drop of the conductive fluid on the tip of the nozzle. A second voltage pulse is applied across the first and second conductors to change the approximately hemispherical hanging drop to be approximately conical. A droplet of the conductive fluid is ejected from the approximately conical hanging drop.

In a preferred embodiment, the width of the second voltage pulse ranges between about 0 ms and about 20 ms, and the rise time of the second voltage pulse ranges between about 3 μs and about 5 μs. The magnitude of the second voltage pulse can be greater than the magnitude of the first voltage pulse and the width of the first voltage pulse can be greater than the width of the second voltage pulse.

A substrate, positioned below the second conductor, is also provided for receiving the droplet. In a preferred embodiment, the second conductor includes a conducting ring. The conducting ring is positioned below and concentric about the first conductor. In this configuration, the electric fields produced by the first and second voltage pulses are approximately symmetric about a vertical axis of the nozzle. The conducting ring can also be used to measure the presence of and an approximate size of the ejected droplet. The presence and approximate size of the droplet is measured based on an induced electromagnetic signal. The electromagnetic signal is induced by the droplet passing through the center of the conducting ring. The measured approximate size of the droplet can also be used to adjust the width of the first and/or second voltage pulses.

In an embodiment of the present invention, the location of the ejected drop can also be focused by applying a focusing electric field. A conducting pin positioned below the second conductor preferably generates the focusing electric field.

The present invention is also directed to a device for ejecting an electrically conductive fluid. The device includes a well plate having a plurality of sockets, one or more well modules that can be inserted and removed from the sockets, a conducting ring corresponding to each of the sockets of the well plate, a substrate for receiving the conductive fluid, and a high voltage source for producing high voltage pulses. Each of the well modules includes a reservoir for storing the conductive fluid and a conducting nozzle for ejecting the conductive fluid. The conductive fluid can be transported from the reservoir to the nozzle. Each of the conducting rings are positioned below and aligned with the corresponding socket. The substrate is positioned below the conducting rings. The high voltage pulses are produced between the conducting nozzle of each well module inserted into a socket and the conducting ring corresponding to the same socket. The high voltage pulses cause the ejection of one or more droplets of the conductive fluid from the nozzle. The droplets fall through the center of the conducting ring corresponding to the same socket.

In an embodiment, a sensing circuit is attached to one or more of the conducting rings for sensing the presence and approximate size for one or more the droplets passing through the center of the conducting ring. The presence and approximate size of the droplets can be used to adjust properties of the applied high voltage pulses.

The conducting nozzle preferably includes a metal capillary tube that allows the conductive fluid to flow in the center of the tube. Alternatively, the conducting nozzle includes a solid cylindrical electrode that allows the conductive fluid to flow on the surface of the electrode. The well modules can also include an embedded memory chip for storing data related to the ejection of the conductive fluid. The fluid ejector device can also include a control circuit electrically connected to the conducting nozzle of one or more of the well modules. The control circuit can provide independent control of the high voltage pulses.

### BRIEF DESCRIPTION OF THE FIGURES

The present invention together with its objectives and advantages will be understood by reading the following description in conjunction with the drawings, in which:

FIGS. 1A-1F show an example of ejecting a droplet by applying multiple voltage pulses according to the present invention.

FIG. 2 shows an example device, including removable well modules, for ejecting a conductive fluid according to the present invention.

FIG. 3 shows a cross-section of an example removable well module according to the present invention.

FIG. 4 shows a cross-section of an example socket for receiving a well module according to the present invention.

FIG. 5 shows an example fluid ejector device with control 520 and sensing 530 circuits according to the present invention.

FIG. 6 shows a flow chart for fluid ejection with feedback according to the present invention.

### DETAILED DESCRIPTION OF THE INVENTION

Many applications, particularly in biopharmaceutical and genetic research, require printing conductive fluids onto a surface, such as for microarray printing. Oftentimes, these applications require precise fluid ejection to accurately place a desired amount of the fluid onto a substrate. Precision printing is a difficult task that generally requires extensive time and/or cost. The present invention is directed to ejection of electrically conductive fluid for precise droplet size and location control using multiple high voltage pulses.

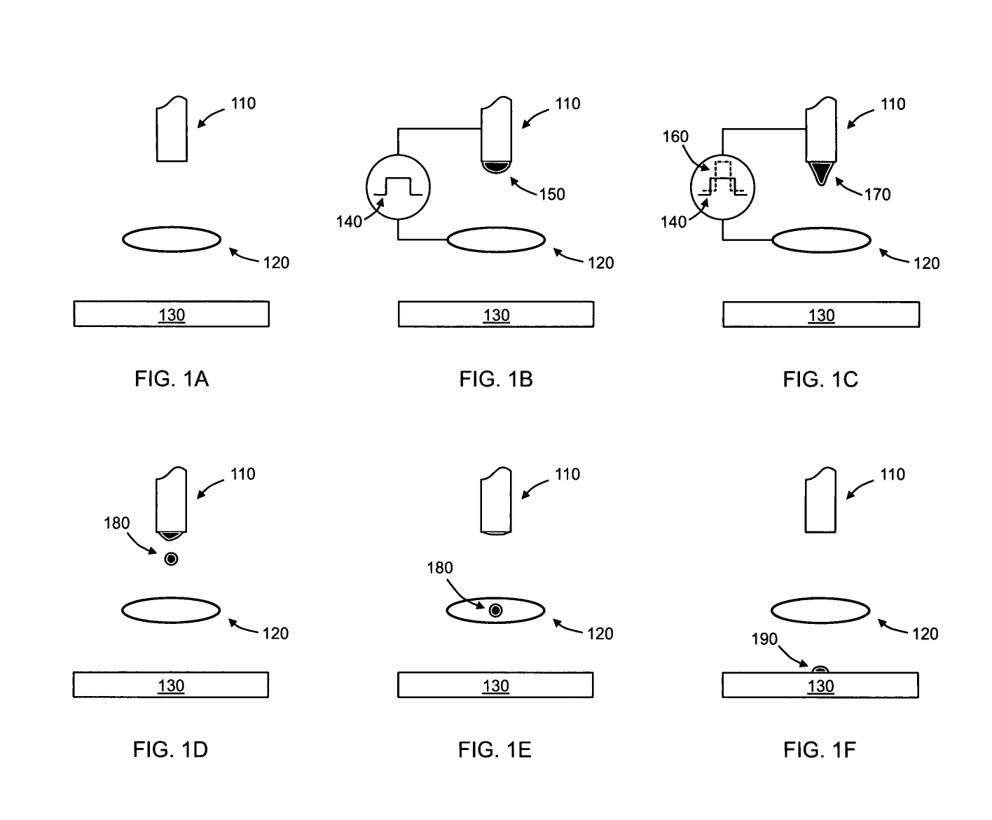

FIGS. 1A-1F show the steps of ejecting a droplet of an electrically conductive fluid or powder from a nozzle 110 onto a substrate 130 according to an embodiment of the present invention. The electrically conductive fluid can include a biological fluid, a DNA sample, a virus, a cell, a protein, or any mixture thereof. The electrically conductive fluid is transported to a nozzle 110, which also includes a first electrical conductor. A high voltage source is connected to the first conductor of the nozzle 110 and a second conductor 120. FIG. 1B shows a first voltage pulse 140 applied across the first conductor of the nozzle 110 and the second conductor 120. Because of the electrically conductive nature of the fluid, the first voltage pulse 140 draws the fluid out of the nozzle 110. However, the first voltage pulse 140 is insufficient to eject the fluid. Instead, the fluid forms an approximately hemispherical hanging drop 150 from the nozzle 110.

FIG. 1C shows the application of a second voltage pulse 160 across the first conductor and the second conductor 120. The second voltage pulse 160 causes the approximately hemispherical hanging drop 150 to become approximately conical. The conical fluid is referred to as a Taylor cone 170. As shown in FIGS. 1D-1F, the second voltage pulse 160 causes the Taylor cone 170 to eject a fluid droplet 180 onto the substrate 130.

In a preferred embodiment, the second conductor 120 is located between the nozzle 110 and the substrate 130. Furthermore, the second conductor 120 includes a conducting ring that is positioned below and concentric about the conductor of the nozzle 110. With such a configuration, the electric field produced by the first and second voltage pulses is approximately symmetrical about a vertical axis of the conductors. The symmetrical field directs the droplet to fall at a precise location directly below the center of the conducting ring 120. FIG. 1E shows the droplet 180 falling through the center of the conducting ring 120. In an embodiment, the motion of the droplet 180 through the center of the conducting ring 120 can be used to detect the presence and approximate size of the ejected droplet 180.

The conducting ring 120 can be an electrically grounded copper ring or a metallic coil, preferably of a fine magnet wire. In an embodiment, the conducting ring 120 is located about 2-3 mm below the nozzle 10 and has a diameter of about 3 mm.

In addition to precise location control, the multiple voltage pulse ejection method of the present invention allows for size control of the deposited droplets. Droplet size is controlled by tuning the voltage pulse widths and magnitudes. In an embodiment, a fluid spot 190 dispensed onto the substrate 130 can have a diameter ranging from about 20 μm to about 1 mm. In an exemplary embodiment, multiple spots are deposited onto the substrate 130, each spot having a diameter of about 200 μm and a spacing of about 400 μm between spots.

In an embodiment of the present invention, the first 140 and second 160 voltages pulses are high voltage pulses, ranging from between 0 V to 5000 V, with a pulse width between about 0 s and 20 ms, and a rise time less than about 10 μs. The rise time preferably ranges between about 3 μs and about 5 μs. The optimal magnitudes and widths of the voltage pulses can depend on properties and position of the nozzle 110, position and size of the second conductor 120, position of the substrate 130, as well as properties of the conductive fluid. For example, uncontrollable spraying or spitting jets can result when very large voltages are applied. In a preferred embodiment, the magnitude of the second voltage pulse 160 is greater than or equal to the magnitude of the first voltage pulse 140. In addition, the width of the first voltage pulse 140 is preferably greater than the width of the second voltage pulse 160.

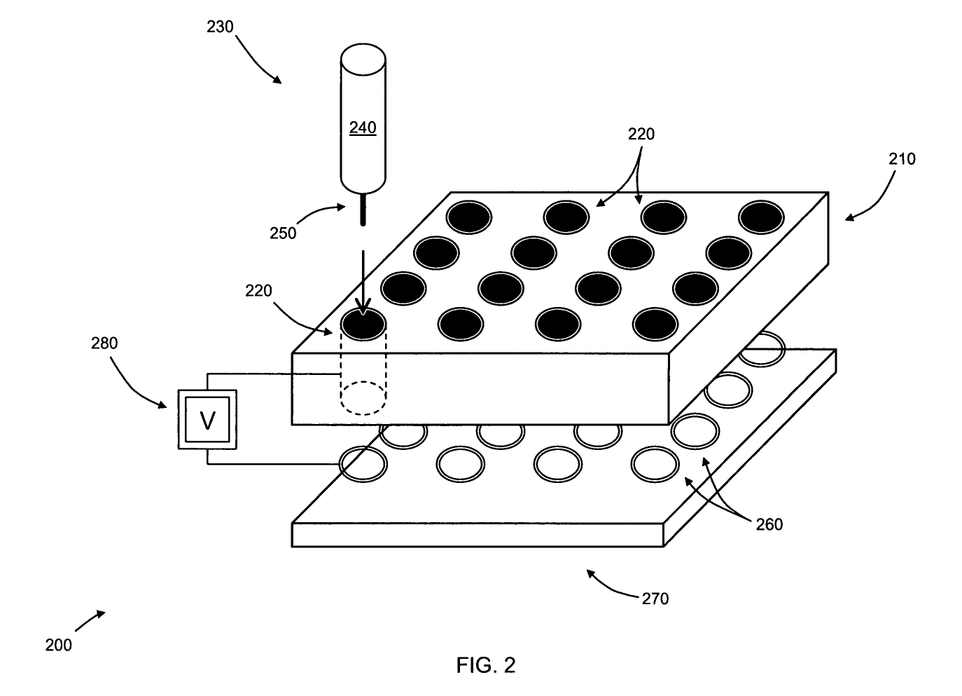

FIG. 2 shows an example device 200 for ejecting an electrically conductive fluid. The device 220 includes a well plate 210, one or more well modules 230, one or more conducting rings 260, a substrate 270, and a high voltage source 280. The well plate 210 includes multiple sockets 220 for receiving the well modules 230. In a preferred embodiment, the spacing and size of the sockets 220 are compatible with standard existing equipment, e.g. the well plate 210 has socket spacing 220 of 4.5 mm or 9 mm. In particular, the well plate 210 of the present invention can have an arrangement of sockets similar to standard 48, 96, 384, or 1536 well plates. Custom well plate configurations can also be used. Preferably, the number of conducting rings 260 corresponds to the number of sockets 220 and each conducting ring 260 is positioned below and aligned with its corresponding socket 220.

Each well module 230 includes a reservoir 240 for storing the conductive fluid and a nozzle 250 fluidically connected to the reservoir 240. The nozzle 250 is preferably a conducting nozzle and is electrically connected to the high voltage source 280. The device 200 ejects fluid by the application of multiple high voltage pulses as described above and in FIG. 1 to print spots on the substrate 270. In an embodiment, the well plate 210 and/or substrate 270 is positioned by a computer-controlled x-y stage to control the location of each spot.

It is important to note that the well module 230 of the present invention can be independently inserted and removed from the sockets 220 of the well plate 210 in contrast to existing designs where the fluid is stored directly in the wells of the well plate. Removable well modules 230 allow for independent control of the droplet ejection. In other words, any desired pattern of ejection can be accomplished simply by either inserting well modules 230 only in the desired sockets 220 or by electronically controlling the application of the voltage pulses. In addition, each of the well modules 230 can be refilled as needed due to the typically non-uniform ejection rates of each well module 230. The independent filling and refilling of the well modules 230 also decreases the possibility of contamination between fluids in the modules. Since the removable well modules 230 can be manipulated separately from the well plate 210, the cost of maintenance can be further reduced. Furthermore, the removable well modules 230 can also be easily stored separately from the rest of the device 200.

It is also important to note that the substrate 270 is positioned below the conducting rings 260. This position of the substrate 270 minimizes the effect of the substrate 270 on the electric fields formed by the voltage pulses. In other words, when the substrate 270 is placed below the conducting rings 260, material properties of the substrate 270, such as the dielectric constant, do not have a significant effect on the ejection performance of the device 200. For this reason, the substrate 270 can include a large variety of materials, including paper or metal. Due to this flexibility in substrate materials, printing in the present invention can be extended to areas, such as high precision etching of printing plates or circuit boards.

Unlike the substrate, dielectric effects from the well plate 210 can be significant to the formation of the electric fields. By extending the length of the conducting nozzle 250, the dielectric effects of the well plate 210 can be reduced. In a preferred embodiment, the conducting nozzle 250 has a length in the millimeter scale.

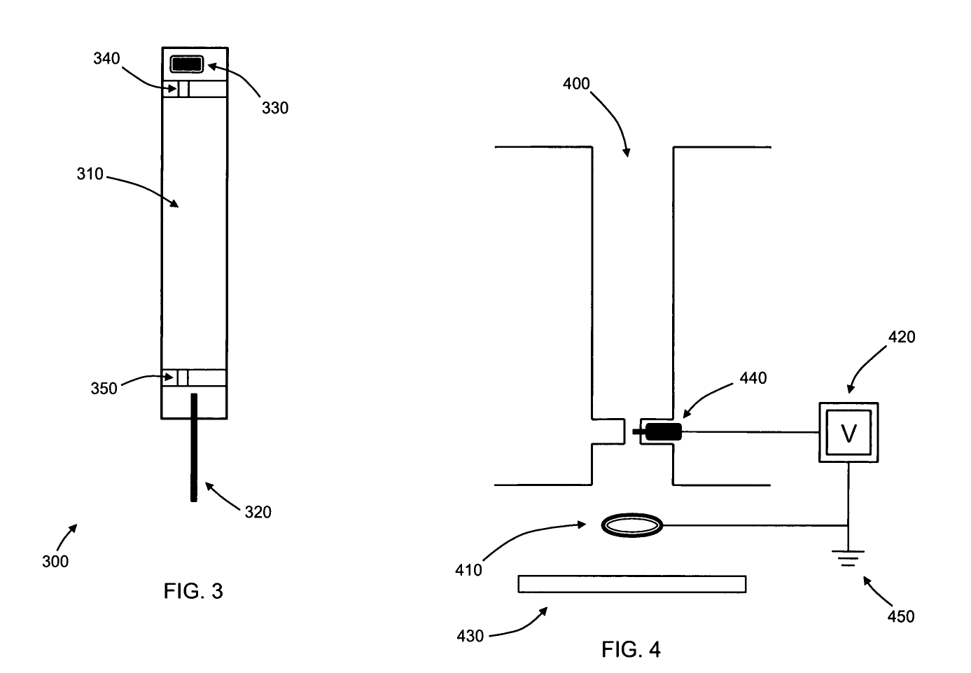

A cross-section of an example removable well module 300 is shown in FIG. 3. The well module 300 includes a reservoir 310 for storing the conductive fluid and a conducting nozzle 320. In an embodiment, the reservoir 310 holds about 0.1 to about 1.0 mL of fluid. The conductive fluid can be transported from the reservoir 310 to the nozzle 320, such as through a valve 350. The conducting nozzle 320 can include any material or structure that permits fluid transport and is electrically conductive. Preferably, the conducting nozzle 320 includes a non-corrosive conducting material, such as stainless steel. In a preferred embodiment, the nozzle 320 is a metal capillary tube and the conductive fluid is delivered in the center of the capillary tube. In an alternative embodiment, the conducting nozzle 320 is a solid cylindrical electrode and the conductive fluid flows on the surface of the electrode. The solid electrode can also include a coating to promote fluid flow on the surface of the electrode.

In certain embodiments, a nozzle structure at the tip can be used to mechanically pre-form the Taylor cone before any voltage pulse is applied. The structure can include a glass, plastic, or metal thin filament, such as a wire.

In an embodiment, the valve 350 between the reservoir 310 and the nozzle 320 can be open or closed to allow or prevent, respectively, fluid from flowing from the reservoir 310 to the nozzle 320. When closed, the valve 350 allows the nozzle 320 to be cleaned or otherwise maintained without contaminating the conductive fluid stored in the reservoir 310. In addition, the valve 350 can be closed during filling. A venting valve 340 can also be provided at the top of the well module 300. When open, the venting valve 340 allows the fluid reservoir 310 to equalize with the ambient air pressure. The valve 350 and/or the venting valve 340 can be opened automatically when the well module 300 is inserted into the well plate. Conversely, the valve 350 and/or the venting valve 340 can be closed automatically upon removable of the well module 300 from the well plate.

As shown by FIG. 3, the well module 300 can also include an embedded memory chip 330 for storing data related to the storage and/or ejection of the conductive fluid. In particular, the memory chip 330 can store a list of the recent contents of the well module 300 and a machine-readable ID code for uniquely identifying the well module 300.

FIG. 4 shows a cross-section of a fluid ejector device, including a socket 400, a conducting ring 410, a high voltage source 420, and a substrate 430. A well module can be removed or inserted into the socket 400. An electrical contact 440 ensures that the inserted well module is electrically connected to the high voltage source 420. In an embodiment, upon insertion of a well module, the conducting nozzle of the well module comes into contact with the electrical contact 440. The high voltage source 420 is used to apply voltage pulses across the conducting nozzle of the inserted well module and the conducting ring 410. In a preferred embodiment, the conducting ring 410 is grounded 450.

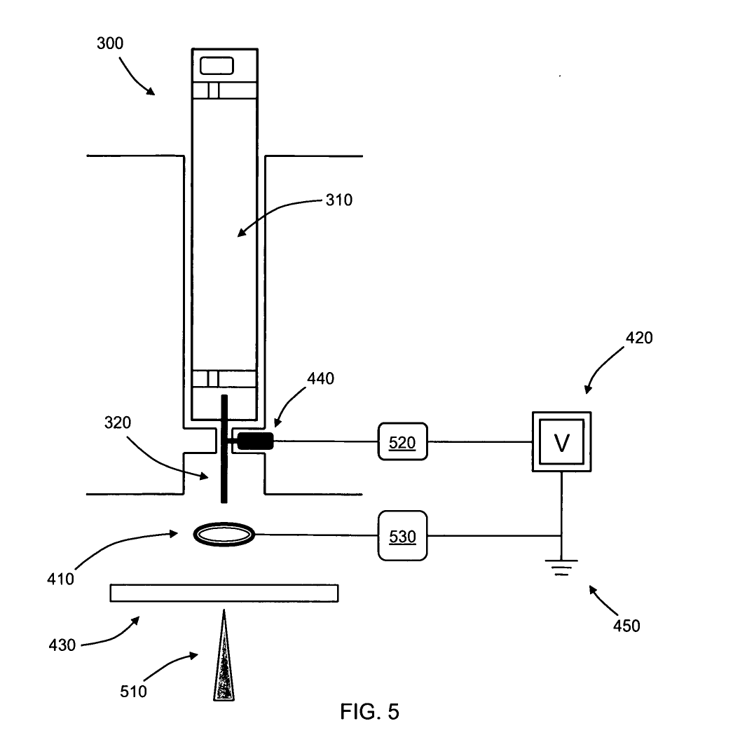

FIG. 5 shows a cross-section of a region of the fluid ejector device. The device includes a well module 300 inserted into a socket of the well plate. In an embodiment, the fluid ejector device includes a conducting pin 510 for focusing the motion of an ejected droplet. Though FIG. 5 shows the conducting pin 510 located below the substrate 430 and aligned with the conducting ring 410, the conducting pin 510 can be located at any position. In addition to or in replacement of the conducting pin 510, one or more electrodes can be positioned to focus the droplet onto a desired location on the substrate 430. Focusing is accomplished by applying a focusing electric field while the droplet is falling.

The device as shown in FIG. 5 also includes a control circuit 520 electrically connected to the conducting nozzle 320 of one or more inserted well modules 300. The control circuit 520 is also communicatively connected to the high voltage source 420 and allows for independent control of the high voltage pulses for each of the inserted well modules 300. The control circuit 520 can be used to apply different high voltage pulse configurations to different well modules 300 for providing specific desired spot patterns. The control circuit 520 may be necessary when the well modules 300 contain different conductive fluids, as different pulse properties may exist for different conductive fluids. The control circuit 520 may also be used program for non-uniform spot sizes between different well modules 300.

It is important to note that a preferred embodiment of the fluid ejector device includes a sensing circuit 530 connected to one or more of the conducting rings 410. Amplifiers and other electronic components can be included with the sensing circuit 530. The sensing circuit 530 is capable of sensing a presence of and charge on the ejected droplet. The presence and charge on the droplet is measured based on an induced electromagnetic signal, such as a electric current. The electromagnetic signal is induced by the droplet passing through the center of the conducting ring 410. The measured charge on the droplet passing through the conducting ring for a given conducting fluid can be related to the size of the droplet by calibrating the droplet charge with a recorded video image of the droplet in flight. Thus, the sensing circuit 530 is effectively capable of sensing a presence and approximate size of the ejected droplet.

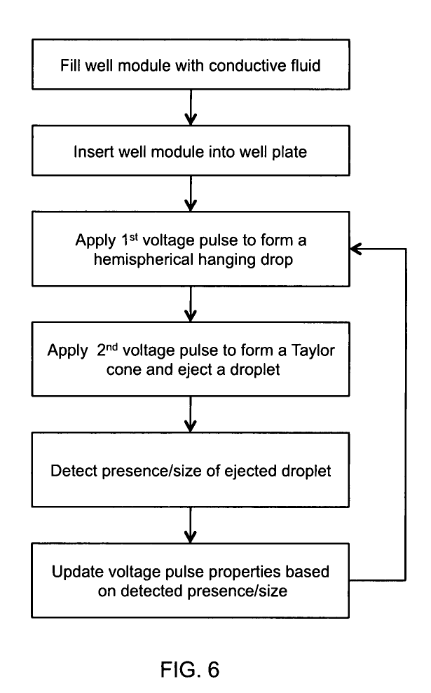

The detection of the presence and size of the droplets can be merely informative for the operator of the fluid ejector device. In addition, the measured presence and approximate size of the droplet can also provide feedback to adjust properties of the voltage pulses, such as the magnitude and width of the pulses. FIG. 6 shows a flow chart of the fluid ejection with feedback in a preferred embodiment of the present invention. The adjustments of the voltage pulse properties can be accomplished automatically and/or iteratively when the sensing circuit 530 is directly connected to the high voltage source 420.

As one of ordinary skill in the art will appreciate, various changes, substitutions, and alterations could be made or otherwise implemented without departing from the principles of the present invention, e.g. the nozzle can include any electrically conductive material. Accordingly, the scope of the invention should be determined by the following claims and their legal equivalents.

What is claimed is:

1. A method for ejecting a droplet of an electrically conductive fluid, said method comprising:
(a) providing a nozzle, wherein said electrically conductive fluid can be transported through said nozzle, and wherein said nozzle comprises a first conductor;
(b) providing a second conductor, wherein said second conductor is positioned below said nozzle;
(c) applying a first voltage pulse to form a hanging drop of said conductive fluid, wherein said hanging drop hangs on the tip of said nozzle, and wherein said hanging drop is approximately hemispherical; and
(d) applying a second voltage pulse to change said approximately hemispherical hanging drop to be approximately conical, and wherein said droplet is ejected from said approximately conical hanging drop,
wherein said first and second voltage pulses are applied across said first and said second conductors.

2. The method as set forth in claim 1, further comprising providing a substrate for receiving said ejected droplet, wherein said substrate is positioned below said second conductor, wherein said second conductor comprises a conducting ring, wherein said conducting ring is positioned below and concentric about said first conductor, whereby the electric fields produced by said first and second voltage pulses are approximately symmetric about a vertical axis of said nozzle.

3. The method as set forth in claim 1, further comprising measuring a presence and an approximate size of said ejected droplet.

4. The method as set forth in claim 3, wherein said second conductor comprises a conducting ring, wherein said conducting ring is positioned below and concentric about said nozzle for said droplet to pass through the center of said conducting ring, wherein an electromagnetic signal is induced to said conducting ring by the motion of said droplet through the center of said conducting ring, and wherein said presence and said approximate size of said ejected droplet are measured based on said induced electromagnetic signal.

5. The method as set forth in claim 3, further comprising adjusting the width of said first voltage pulse, the width of said second voltage pulse, or the widths of said first and said second voltage pulses, wherein said adjusting is based on said measured approximate size of said ejected droplet.

6. The method as set forth in claim 1, further comprising focusing the location of said ejected droplet, wherein said focusing comprises applying a focusing electric field to said ejected droplet.

7. The method as set forth in claim 6, wherein said focusing electric field is formed by a conducting pin, and wherein said conducting pin is positioned below said second conductor.

8. The method as set forth in claim 1, wherein the width of said first voltage pulse is greater than the width of said second voltage pulse.

9. The method as set forth in claim 1, wherein the width of said second voltage pulse ranges between about 0 ms and about 20 ms, and wherein the rise time of said second voltage pulse ranges between about 3 μs and about 5 μs.

10. The method as set forth in claim 1, wherein the magnitude of said second voltage pulse is greater than or equal to the magnitude of said first voltage pulse.

11. The method as set forth in claim 1, further comprising storing said conductive fluid in an individual well module, wherein said nozzle is connected to the bottom of said well module, wherein said conductive fluid stored in said well module can be delivered to said nozzle for ejection, wherein said well module can be inserted into a well plate, and wherein said well module is removable from said well plate.

12. A device for ejecting an electrically conductive fluid, said device comprising:
(a) a well plate having a plurality of sockets;
(b) one or more well modules, wherein each of said well modules can be inserted into and removed from one of said sockets, and wherein each of said well modules comprises:
(i) a reservoir for storing said conductive fluid; and
(ii) a conducting nozzle for ejecting said conductive fluid, wherein said conductive fluid can be transported from said reservoir to said conducting nozzle,
(c) a conducting ring corresponding to each of said plurality of sockets of said well plate, wherein each of said conducting rings is positioned below and is aligned with said corresponding socket;
(d) a substrate for receiving said conductive fluid, wherein said substrate is positioned below said conducting rings; and
(e) a high voltage source for producing multiple high voltage pulses, wherein said high voltage pulses are produced between said conducting nozzle of each of said well modules inserted in one of said sockets and said conducting ring corresponding to the same of said sockets, wherein said high voltage pulses causes the ejection of one or more droplets of said conductive fluid from said conducting nozzle, and wherein said one or more droplets pass through the center of said conducting ring corresponding to the same of said sockets.

13. The device as set forth in claim 12, wherein said high voltage source produces a first high voltage pulse and a second high voltage source for ejecting a droplet of said conductive fluid from each of said well modules inserted into said well plate, wherein said first high voltage pulse forms an approximately hemispherical hanging drop of said conductive fluid on the tip of said conducting nozzle of the same of said well modules, wherein said second high voltage pulse changes said approximately hemispherical hanging drop to be approximately conical, and whereby said droplet of said conductive fluid is ejected from said approximately conical drop.

14. The device as set forth in claim 12, further comprising a sensing circuit attached to one or more of said conducting rings, wherein said sensing circuit is capable of sensing a presence and an approximate size for one or more of said droplets passing through the center of the same of said conducting rings, wherein said sensing is accomplished by measuring an induced electromagnetic signal at the same of said conducting rings, and wherein said electromagnetic signal is induced by said one or more droplets falling through the center of the same of said conducting rings.

15. The device as set forth in claim 12, wherein said conducting nozzle of each of said well modules comprises a metal capillary tube, and wherein said conductive fluid flows in the center of said metal capillary tube.

16. The device as set forth in claim 12, wherein said conducting nozzle of each of said well modules comprises a solid cylindrical electrode, and wherein said conductive fluid flows on the surface of said solid cylindrical electrode.

17. The device as set forth in claim 12, wherein each of said well modules further comprises an embedded memory chip for storing data related to said ejection of said conductive fluid.

18. The device as set forth in claim 12, further comprising a control circuit electrically connected to said conducting nozzle of one or more of said well modules, wherein said control circuit provides independent control of said high voltage pulses for each of said well modules.

19. The device as set forth in claim 12, further comprising a focusing pin for focusing the motion of said ejected conductive fluid, wherein said focusing pin is positioned below said substrate.

20. The device as set forth in claim 12, wherein said conductive fluid comprises a biological fluid, a DNA sample, a virus, a cell, a protein, or any mixture thereof.
